(19) United States
(12) Patent Application Publication
(10) Pub. No.: US 2006/0118990 A1
(43) Pub. Date: Jun. 8, 2006

(54) Process for the production of a rapid prototyping model, a green compact, a ceramic body, a model with a metallic coating and a metallic component, and use of a 3D printer

(75) Inventors: Stephan Dierkes, Bremen (DE); Thomas Wiest, Hunfeld (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: BEGO Bremer Goldschlagerei Wilh, Herbst GmbH & Co. KG

(21) Appl. No.: 11/260,303

(22) Filed: Oct. 28, 2005

(30) Foreign Application Priority Data
Oct. 28, 2004 (DE) 102004052365.7-16

(51) Int. Cl. B29C 35/08; B29C 41/02; B29C 33/76; C04B 35/00; B28B 1/14; C25B 7/00

(52) U.S. Cl. 264/104; 264/308; 264/401; 264/105; 264/317; 204/471

(57) ABSTRACT

The invention relates to a process for the production of a rapid prototyping model, in particular a rapid prototyping model for electrolytic or electrophoretic deposition. The steps (a) provision of a mixture of one or more fluid, solidifiable materials and one or more electrically conductive substances and subsequently (b) production of the rapid prototyping model by rapid prototyping using the mixture, such that the rapid prototyping model produced is electrically conductive in one or more areas of its surface due to the presence of the electrically conductive substance or substances and has a pore structure in its inside, are proposed. The invention furthermore relates to a process for the production of a ceramic green compact, a process for the production of a ceramic component, a process for the production of a rapid prototyping model with a metallic coating, a process for the production of a metallic component and the use of a 3D printer having one, two or more print systems and/or print heads for printing out a rapid prototyping model.

The invention relates to a process for the production of a rapid prototyping model for electrolytic or electrophoretic deposition. According to a further aspect, the invention relates to a process for the production of a ceramic green compact. The invention furthermore relates to a process for the production of a ceramic component, a process for the production of a rapid prototyping model with a metallic coating and a process for the production of a metallic component. Finally, the invention relates to the use of a 3D printer.

The production of rapid prototyping models of, for example, wax or plastic is known. Inkjet technology, for example, is employed for this. In this process, small beads of liquid material are released from one or more print head/heads and impinge and solidify on the rapid prototyping model being formed. The rapid prototyping model is therefore built up “point-wise”.

A further process for additive building up of a rapid prototyping model is stereolithography. In this procedure, resin is applied in layers and irradiated selectively with light. The regions of the resin which are irradiated crosslink. Local solidification occurs. The excess non-crosslinked resin content can be removed easily. A three-dimensional rapid prototyping model remains.

In particular, very complex rapid prototyping models can be produced with a high accuracy by the two processes mentioned. They serve, for example, as models for model casting in dentistry or the jewellery industry. However, they also serve as a base body or mould for electrophoretic or electrolytic deposition. In this context, the electrophoretic and electrolytic deposition is distinguished by the realization of tiny structure details and excellent surfaces.

Hitherto, the surface of the rapid prototyping model was rendered electrically conductive e.g. with a conductive lacquer (e.g. silver conductive lacquer) or by sputtering before the electrophoretic or electrolytic deposition.

The rapid prototyping models are then coated, for example electrolytically; alternatively, a slip is deposited in an electrophoretic process on the rapid prototyping models coated with conductive lacquer. During this operation, a ceramic layer is deposited, from which a green compact and finally a ceramic component are produced in further process steps.

Examples of uses which emerge from the combination of the rapid prototyping processes with the rendering of the models conductive and the coating or deposition of a slip lie in the production of metallic or ceramic coverings or mouldings. Individual parts and also small series can therefore be produced from the final material with a saving in cost and time. Furthermore, however, the production of three-dimensional microstructures or microstructured surfaces leads to novel fields of use in microsystem and microprocess technology.

A disadvantage of application of a conductive lacquer is that changes in geometry which cannot be accurately predetermined occur during its use. In the sputtering process for the rapid prototyping model, lower layer thicknesses occur on structure areas perpendicular to the sputter stream than on structure areas which run horizontally to the sputter stream. The thinner layers formed in the last case have a higher electrical resistance. Both types of rendering the model conductive, application of a conductive lacquer and sputtering, are labour-intensive and, in the case of more complex components in particular, cannot be carried out mechanically.

Certain cast models of a solidifiable material which has been rendered conductive by addition of conductive substances have already been employed for electrophoretic or electrolytic deposition of ceramic layers on a model. Cf. Both, von H., Dauscher, M,. Hausselt, J. (Materials Process Technolopgy) Elektrophoretische Herstellung keramischer Mikrostrukturen [Electrophoretic production of ceramic microstructures], Keramische Zeitschrift, 56, 2004, 298-303.

WO 02/064335 A1 discloses certain processes of 3D printing.

DE 103 32 802 A1 discloses processes for the production of an oxide ceramic structure which can be subjected to loads.

DE 103 11 446 A1 discloses a process for combining material for the production of shaped bodies by means of selective inhibition.

EP 0 420 614 A1 discloses processes for coating stereolithographic parts.

The invention is based on the object of overcoming disadvantages in the prior art.

The invention achieves the object by a process for the production of a rapid prototyping model for electrolytic or electrophoretic deposition, with the steps:
provision of a mixture of one or more fluid, solidifiable materials and one or more electrically conductive substances and subsequently
production of the rapid prototyping model by rapid prototyping using the mixture, such that the rapid prototyping model produced is electrically conductive in one or more areas of its surface due to the presence of the electrically conductive substance or substances and has a porous structure in its inside.

The invention furthermore achieves the object by a process for the production of a ceramic green compact with the steps
production of a rapid prototyping model by a process according to the invention (preferably in a preferred embodiment, in this context see below),
optionally reduction of the surface imperfections of the rapid prototyping model, in particular by reworking by removal of material, in particular sandblasting,
electrolytic and/or electrophoretic deposition of a slip on the rapid prototyping model, so that a ceramic layer forms,
optionally drying of the ceramic layer deposited,
optionally working of the ceramic layer and/or of the rapid prototyping model by removal of material, additional application of ceramic material to the ceramic layer and/or by application of a solidifying agent and
removal of the model, in particular by melting out, burning out or dissolving out,
   such that a ceramic green compact is formed.

The invention furthermore achieves the object by a process for the production of a ceramic component with the steps
production of a green compact by a process according to the invention for the production of a green compact,
optionally reworking of the surface of the green compact by removal of material and
heat treatment of the green compact, so that a ceramic component is formed.

The invention moreover achieves the object by a process for the production of a rapid prototyping model with a metallic coating, with the steps:
production of a rapid prototyping model by a process according to the invention for the production of a rapid prototyping model (preferably in a preferred embodiment, in this context see below),
optionally reduction of the surface imperfections, preferably by reworking by removal of material, preferably sandblasting,
electrolytic or electrophoretic deposition of a metal layer on the rapid prototyping model, so that a model with a metallic coating is formed, and
optionally reworking of the metallic coating and/or of the rapid prototyping model, preferably by milling and/or polishing.

The invention moreover achieves the object by a process for the production of a metallic component with the steps:
production of a rapid prototyping model with a metallic coating by a process according to the invention for the production of a rapid prototyping model with a metallic coating, wherein the metal layer is self-supporting,
removal of the rapid prototyping model, in particular by melting out, burning out or dissolving out, so that the self-supporting metal layer remains as a metallic component, and
optionally reworking of the metal component, preferably by milling and/or polishing.

Finally, the invention achieves the object by the use of a 3D printer with one, two or more print systems and/or print heads for printing out a rapid prototyping model which comprises one or more solidified materials and which comprises one or more electrically conductive substances in one or more areas of its surface.

In the following, rapid prototyping is understood as meaning processes which produce, from data stored in a computer which describe the geometry of a component, a component having the same geometric dimensions without human intervention in respect of shaping being necessary. Before the actual rapid prototyping, the components described by geometric data in the computer are advantageously tested in respect of their later physical properties by the use of software tools. It is thus appropriate e.g. to calculate the mechanical stability and the weight of the finished component and to compare them with the specification.

A distinction may be made between subtractive and additive rapid prototyping. In subtractive rapid prototyping, material is removed from the solid material. On the other hand, in additive rapid prototyping, which is particularly suitable for carrying out the processes according to the invention, material is deposited on the rapid prototyping model being formed and the rapid prototyping model is built up in this way.

A fluid material is understood as meaning a material which has a viscosity of less than 1,000 Pa·s at a given temperature and under a given pressure. Fluid materials are solidifiable in particular if they can be converted into the solid state by cooling, evaporation of a volatile constituent, polymerization, photocuring, setting or crosslinking. In particular, substances which are solid at 20° C. under 1,013 hPa and have a viscosity of less than 10 Pa·s at elevated temperature (e.g. in the range from 50° C. to 250° C.) under 1,013 hPa belong to the fluid, solidifiable materials at this temperature and under this pressure. They (re)solidify on cooling.

In the case of materials which have no defined melting point (e.g. multi-phase substances), that temperature at which the viscosity of the material under 1,013 hPa falls below 10 Pa·s is regarded as the melting point. It goes without saying that in providing the fluid, solidifiable material or the fluid, solidifiable materials, solid or fluidizable, resolidifiable materials can be used as the starting materials which are fluidized.

Mixtures are, for example, suspensions, emulsions or solutions.

The mixture employed in the process according to the invention advantageously comprises one or more additives. The mixture advantageously comprises, for example, a dispersing auxiliary which, via electrostatic and/or steric interaction with any particles present, has the effect of homogenization and stabilization thereof. The presence of a wetting agent which renders possible the addition of one or more electrically conductive powders having a high surface tension can moreover be envisaged. Materials which serve as thickeners or diluents of the mixture can furthermore be used.

Electrolytic deposition is understood as meaning the migration of ions in a direct electrical field and discharge thereof at an electrode to form a covering of the substance which originates from the ions discharged. The process of industrial utilization of electrolytic deposition is differentiated into electroplasty (also called electroforming) and electroplating. In electroplasty, metallic objects are produced by electrolytic processes. Electroplating serves to produce metallic coverings. Electroplating can in turn be divided into functional and decorative electroplating.

Functional electroplating serves for production of functional coatings, for example for corrosion protection, for wearing protection, to improve catalytic properties or to improve the electrical conductivity. Examples of functional electroplating are zinc-plating of screws, hard chromium-plating of machine parts, gold-plating or silver-plating of electrical contacts and coating of support substrates with catalytically active metal layers for the preparation of catalysts for the chemical industry or for the production of fuel cells. Decorative electroplating serves for production of metallic decorative layers. Examples are electroplating of plastics, chromium-plating of tubular steel furniture and gold-plating of jewellery and cutlery.

Electrophoretic deposition is understood as meaning migration in a liquid of dispersed particles in a direct electrical field, during which a deposition of these particles occurs in the environment of an electrode. The dispersed particles are as a rule slurried in an aqueous or organic dispersing agent in the presence of peptizers. Particles having pronounce electrical double layers are formed by this procedure. In a sufficiently strong electrical field in the immediate environment of the electrode, the dispersed particles agglomerate and a densely packed particle arrangement which is a precise cast of the surface structure of the electrode forms. Subsequent working steps, such as drying and/or sintering, result in ceramic components which have only low internal stresses, density gradients and variations in composition, which is favourable in respect of their life and wear properties.

An electrically conductive area of a surface is understood as meaning, in particular, a surface area of a spatial section in which the specific electrical resistance is less than 500 Ωm. In the context of the present invention, the electrical conductivity of an electrically conductive area of the surface as a rule results in particular from the fact that the spatial section including this area comprises material which has originated from the mixture of one or more fluid, solidifiable materials and one or more electrically conductive substances during the production of the rapid prototyping model. An electrically conductive substance is understood as meaning, in particular, a substance having a specific electrical resistance of less than 500 Ωm.

A ceramic green compact is understood as meaning a ceramic body which is mechanically stable to the extent that it supports its own weight permanently and is therefore mechanically stable, but which becomes mechanically unstable again by storage in water. Ceramic green compacts can be converted into a ceramic component by sintering. A ceramic component is permanently mechanically stable even in water.

An advantage of the invention is firstly the saving of human work power, since the working step of electrical contacting by application of an electrically conductive layer, for example manually, is omitted. Contacting is particularly easily possible via electrodes if appropriate contacts are already also established during the rapid prototyping. A further advantage is the high dimensional accuracy, since in the process according to the invention no additional layers have to be applied to the surface of the rapid prototyping model. The production of precision components is furthermore possible due to the high dimensional accuracy.

In a preferred process according to the invention, graphite, carbon black, other conductive substances based on carbon (preferably with carbon six-membered ring layers) and/or metal particles, preferably silver particles, are used as electrically conductive substances. It has been found that using these materials it is possible to produce rapid prototyping models which are mechanically stable and at the same time have a particularly good electrical conductivity in one or more areas of their surface because of the presence of the electrically conductive substance. The use of graphite, carbon black and other conductive substances based on carbon (preferably with carbon six-membered ring layers) is particularly preferred.

A further advantage of the invention is that due to the porosity inside the model (that is to say below the upper or outer surface which is to be coated electrophoretically or electrolytically) which is provided according to the invention, removal of the model from the layer deposited or the green compact or component (ceramic and/or metallic) is made considerably easier compared with the use of compact models.

The specific electrical resistance of the conductive areas is less than 500 Ohm Ω m. This contributes to the ceramic or metal layers deposited being not too different in layer thickness.

At very low concentrations of electrically conductive substance, the electrical conductivity of the mixture scarcely differs from the electrical conductivity of the fluid, solidifiable materials. On addition of electrically conductive substance(s), the electrical conductivity of the mixture as a rule increases in proportion to the concentration of the electrically conductive substance(s). During continuous increasing of the concentration of the electrically conductive substance(s) in the mixture, a marked overproportional increase in the electrical conductivity is observed from a certain concentration. The reason for this lies in the formation of a continuous network made of so-called conduction paths through the material. The concentration at which the increase in the conductivity becomes overproportional is the percolation concentration.

If the concentration of the electrically conductive substances in the mixture is plotted against the electrical conductivity (conductivity curve), the percolation concentration is exceeded in particular at concentrations which are higher than the concentration at the first point of inflection where the conductivity curve passes from a convex into a concave curve.

If too high a content of electrically conductive substances is chosen, a mechanical instability of the rapid prototyping model may occur.

Alternatively, such a high content of electrically conductive substances in the mixture is chosen that the rapid prototyping model produced by rapid prototyping is conductive in one or more areas of its surface and at the same time the mixture has material properties which give the mixture a good capacity for use in the rapid prototyping process. The content of conductive substances is limited in its upper value by the properties, determined by the rapid prototyping process, of the material to be built up or removed. For this purpose, in preliminary experiments the content of electrically conductive substances in the mixture is varied within wide limits and the content at which the capacity for use is optimum is determined. In particular, the content of electrically conductive substances is chosen such that the viscosity of the mixture is optimum for carrying out the rapid prototyping process.

It has proved favourable to use electrically conductive substances which comprise small particles, in particular having an average particle diameter in the range of from 5 nm to 50 μm, in particular 10 nm to 10 μm. It has also proved favourable to use electrically conductive substances which have a multimodal particle distribution. This can be a bimodal or trimodal distribution. The viscosity and the conductivity of the material can thereby be favourably influenced.

The addition of copper chloride, preferably 3 to 6 mol per gram of mixture, has also proved to be favourable, especially if the fluid, solidifiable material is an epoxy resin to which carbon black is admixed as an electrically conductive substance.

A process according to the invention which is particularly preferred is one in which during production of the rapid prototyping model the fluid, solidifiable material or the fluid, solidifiable materials are solidified to form a matrix in which the electrically conductive substance or the electrically conductive substances are embedded, so that, together with the matrix, these form a solidified mixture, the specific electrical resistance of which is less than 500 Ohm Ω m.

A process according to the invention which is furthermore preferred is one in which the content of electrically conductive substances in the electrically conductive area of the surface is more than once, preferably more than 1.5 times the percolation concentration, determined at the same relative concentrations of the electrically conductive substances. The result of this is that the electrical voltage which must be applied in working steps of the processes according to the invention for electrolytic or electrophoretic deposition does not have to be too high.

The percolation concentration at the same relative concentrations of the electrically conductive substances is determined in this context as follows: Electrically conductive substance is or electrically conductive substances are added to the fluid solidifiable material or the fluid solidifiable materials which are not simultaneously electrically conductive substances. The ratio of the electrically conductive substances to one another in the mixture always remains constant here. The electrical conductivity of the mixture is determined before and after addition of the electrically conductive substance(s). The addition is repeated several times, so that the dependency of the electrical conductivity of the mixture on the concentration of the electrically conductive substance or the electrically conductive substances is determined in a relatively wide concentration range

Preferably, the fluid, solidifiable material is or the fluid, solidifiable materials are chosen from the group consisting of wax and plastic, in particular thermoplastic and photocuring resin.

In a preferred embodiment of a process according to the invention, at least one electrically conductive substance is simultaneously a fluid, solidifiable material.

A process according to the invention which is particularly preferred is one in which the rapid prototyping model is produced by additive rapid prototyping, in particular by fused deposition modelling and/or stereolithography and/or 3D printing, such as inkjet modelling.

In fused deposition modelling, a continuous filament of plastic or wax is softened/melted and positioned (resolidified). Production of components via stereo-lithography is carried out, for example, via application of a photopolymer in layers and subsequent selective crosslinking of the polymer by means of UV light. In the inkjet process, small beads of material are released in liquid form from a print head, and settle on the model being formed and solidify there.

Another form of 3D printing, inkjet printing, is a process in which previously heated wax or plastic (thermoplastic) or a photopolymer resin leaves the 3D printer in liquid form and solidifies on the component. Inkjet printing can be differentiated by the number of jets and by the number of print heads from which material is released.

Thus, for example, the apparatuses from Solidscape Inc., U.S.A. and BPM Technology operate with one jet (single jet, ballistic particle manufacturing) and wax and thermoplastic as the materials, whereas the inkjet printers from 3D-Systems and from Objet Geometries Ltd. are equipped with several jets (multi-jet modelling, poly-jet) and operate with wax and/or photopolymers as the materials. The systems which operate with several jets lead to significantly faster production of models.

The companies already mentioned each offer apparatuses which are equipped with two or more print heads. This allows rapid prototyping models to be built up from several substances simultaneously or successively in layers. Thus in practice, for example, support structures to assist in undercuts are built up with a further material which differs in its physical properties from the material otherwise used.

A process according to the invention which is particularly preferred is one with the additional step:
provision of a fluid and solidifiable material which is electrically insulating in the solidified state, the rapid prototyping model (which is porous in its inside) being produced by rapid prototyping using this material and the mixture such that at least two electrically conductive areas of its surface are each demarcated from the electrically insulating material such that they are electrically insulated from one another.

An electrically insulating material is understood here as meaning a material having a specific resistance of more than 5,000 Ωm. Wax, For example, meets this criterion.

The result of this is that at least two conductive areas can be set at different electrical potentials. This allows different layer thicknesses to be deposited by electrolytic or electrophoretic deposition at different places on the surface of the rapid prototyping model.

A process according to the invention which is particularly preferred is one in which the rapid prototyping model is produced such that it is electrically conductive in parts of its volume and the electrically conductive areas of its surface are contacted through the electrically conductive parts of its volume. A low internal resistance of the rapid prototyping models is achieved in this manner.

Preferably, the rapid prototyping model is produced by stereolithography, the fluid, solidifiable materials preferably being photocurable and preferably being chosen from the group consisting of photocuring resin and photocurable wax. In this case, the model can also have, in addition to the porosity, regions inside in which the material is not or not completely cured. These regions are closed, so that the liquid material cannot be removed after the model has been built up.

A process according to the invention which is particularly preferred is one with the additional steps:
after provision of the mixture, solidification of the mixture so that a pre-formed body, in particular in the form of a block, is formed and
production of the rapid prototyping model by milling.

This is a subtractive rapid prototyping process. The block produced will preferably have pores only deep in its inside, so that the porous structure is not interfered with during milling and a smooth surface (on which the electrophoretic or electrolytic deposition is to take place) can be achieved. A preferred process according to the invention for the production of a ceramic green compact or a ceramic component or a rapid prototyping model with a metallic coating or a metallic component is one in which the rapid prototyping model is electrically conductive in at least two areas of its surface which are electrically insulated from one another and in which during electrolytic or electrophoretic deposition of the metal layer and/or the electrophoretic deposition of the slip on the rapid prototyping model, these at least two areas which are electrically insulated from one another
(a) are placed under a voltage and/or connected without a voltage at different points in time and/or
(b) are placed under voltages which differ from one another,
   so that layers of metal and/or slips are deposited in different thicknesses on the at least two areas which are insulated from one another.

The result of this is that different layer thicknesses can be deposited electrolytically or electrophoretically at various places on the surface.

A particularly preferred process according to the invention for the production of a ceramic component is one in which the heat treatment of the green compact is a sintering to give a porous or a dense ceramic component.

A preferred process according to the invention is one in which a metal layer is deposited electrolytically or electrophoretically on a ceramic layer deposited on the rapid prototyping model, and/or a ceramic layer is deposited electrophoretically on the metal layer deposited on the rapid prototyping model.

In this context, a ceramic layer deposited on the rapid prototyping model is also understood as meaning a ceramic layer which has been deposited on a metal layer which in its turn has been deposited on the rapid prototyping model.

Correspondingly, a metal layer deposited on the rapid prototyping model is also understood as meaning such a metal layer which has been deposited on an abovementioned ceramic layer. Multiple layers can thus be produced by alternate deposition of ceramic and metal layers.

The invention is explained in more detail in the following with the aid of the attached drawing and with the aid of five embodiment examples. The drawing shows:

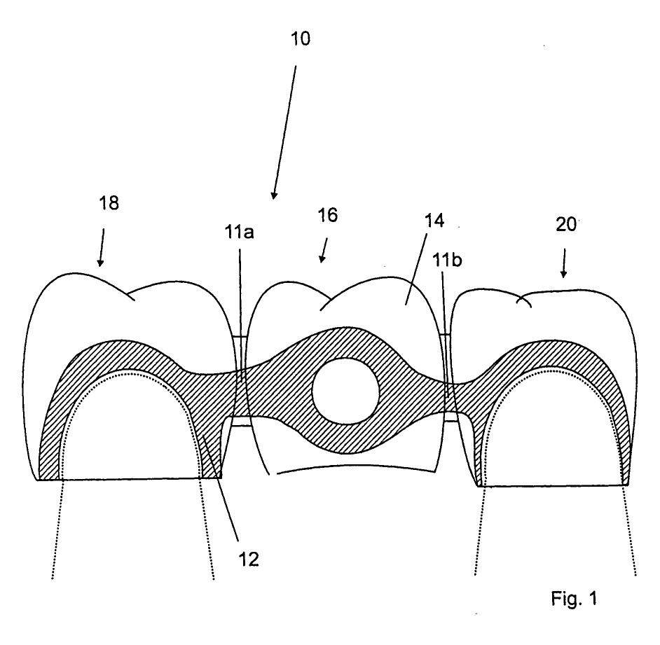

FIG. 1 a longitudinal section view of a ceramic component, in the form of a dental moulding, produced by a process according to one embodiment example of the invention,

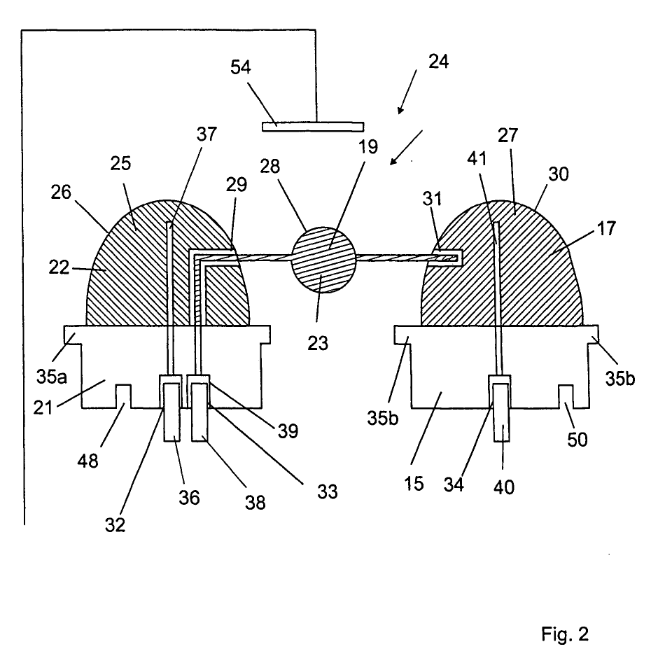

FIG. 2 a rapid prototyping model, in the form of a dental model, produced by a process according to one embodiment example of the invention, in longitudinal section,

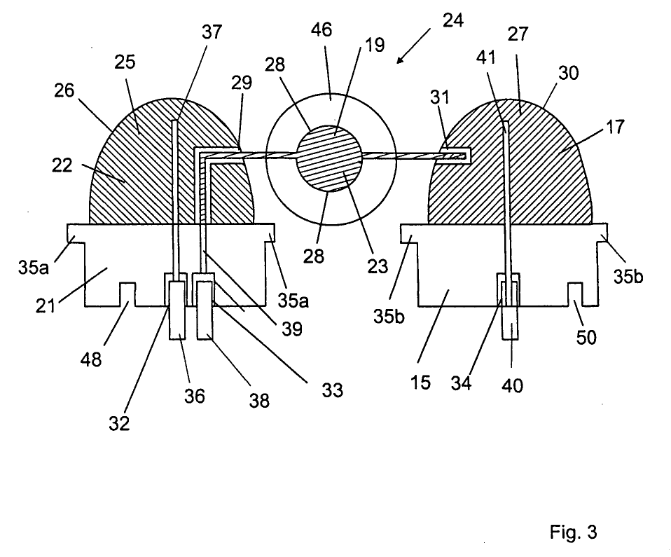

FIG. 3 the rapid prototyping model from FIG. 2 with an added-on ceramic layer, in longitudinal section,

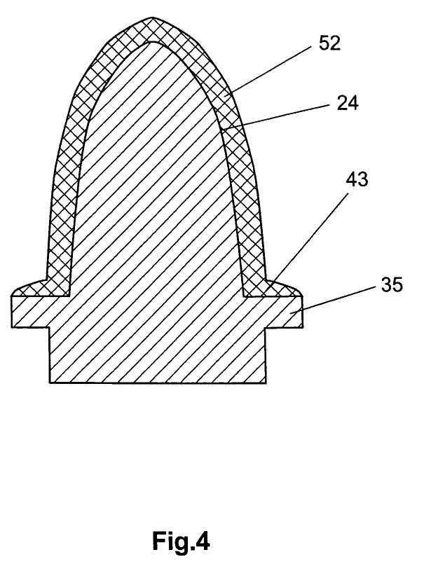

FIG. 4 the diagram of a rapid prototyping model produced by a process according to one embodiment example of the invention, with the preparation shoulder and the ceramic layer deposited,

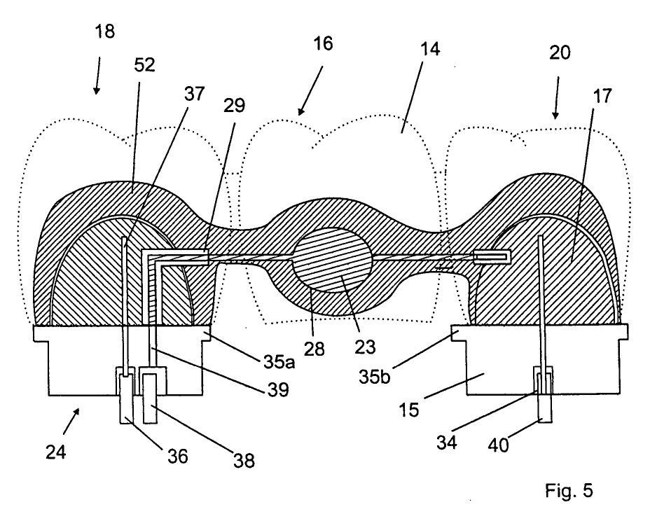

FIG. 5 the rapid prototyping model from FIG. 3 with an added-on continuous ceramic layer, in longitudinal section, and

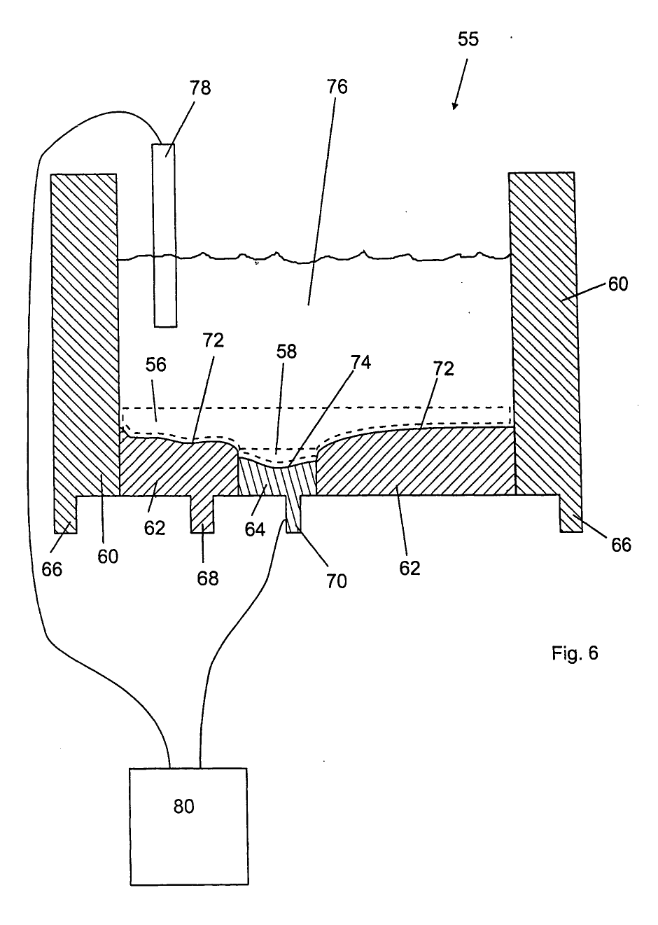

FIG. 6 a cross-section view of a rapid prototyping model for the production of a metallic component by a process according to one embodiment example of the invention.

The invention is first explained with the aid of FIGS. 1 to 5 for the production of a rapid prototyping model in the form of a dental model.

### EMBODIMENT EXAMPLE 1

### Production of a Ceramic Component

The invention is first explained with the aid of the production of a dental moulding (ceramic component) for a three-membered bridge restoration. The bridge restoration comprises an intermediate member which replaces a tooth which is no longer present, and two members which are each mounted on an abutment tooth, i.e. a first and a second abutment tooth.

An impression of the oral cavity of a patient is first taken. A silicone, alginate or polyether impression composition is as a rule employed for this. After the impression composition has hardened, the negative formed is cast with gypsum. The master model is produced from this positive. The master model (not shown) reproduces completely the situation in the mouth of the patient in the context of the impression accuracy.

A data model is created from this master model by scanning. A line scanner of the Speedscan type from BEGO GmbH & Co. KG is employed, for example, for this. The scan data obtained in this way are transmitted to a computer and displayed on a screen. The dental prosthesis is modelled on this data model by means of appropriate software. This is carried out with standard software from BEGO GmbH & Co. KG (SOFTSHAPE CAD software). The geometry of the data model is then enlarged such that a sinter shrinkage which occurs in the further process (e.g. of a ceramic cap) is compensated. The preparation line is additionally modelled on in the data model as a preparation edge. A cement gap is also modelled on in the data model. The cement gap is the space required for cementing the caps on the tooth stumps.

The porosity of the dental model is then specified. In this context, the porosity chosen for the inside of the dental model is greater, while the outer regions have no or a lower porosity.

The geometric shape of the ceramic bridge and the position thereof in the oral cavity of the patient are now calculated and the position and nature of the intermediate member can be specified by calculation. The forces which are to be expected when a corresponding ceramic bridge is used in the oral cavity are now simulated. For this, in the simulation typical compressive and shear forces are applied to the surface and the resulting forces in the ceramic bridge and the surface thereof are determined by means of the finite element method. The places on the ceramic bridge at which the highest forces are to be expected are thereby determined. In addition to the caps, this substantially applies to the intermediate member. It is then calculated whether the material thickness on the intermediate member and the connectors and also on the caps is sufficient to be able to accommodate the forces determined. If this is not the case, the data model of the cap is modified such that a greater material strength is chosen in this point. The simulation calculation described is then carried out again with the modified data model. This iterative process is carried out until a geometry of the ceramic bridge which has the given strength is found.

After the geometric shape of the planned dental moulding 10 (cf. FIG. 1) has been specified by the (calculation) steps described above, the data model of the planned dental moulding existing on the basis of STL data and therefore of the dental model to be produced in the rapid prototyping process is modified in a further calculation step such that the sinter shrinkage is compensated. Three (in the present embodiment example) electrically conductive areas on the surface of the future dental model and the particular contacting thereof are then specified.

The data model is then printed out three-dimensionally on a 3D printer of the T66 type from Solidscape, Inc., Merrimack, USA. During inkjet printing, small beads of liquid material are released by a print head on to the workpiece being formed and solidify there and build up the dental model. The porosity of the dental model is adjusted according to the data model by the density of the beads released.

(a) An electrically insulating wax and (b) a wax which has been rendered electrically conductive with carbon black particles are used for production of the dental model. In the embodiment example, an electrically non-conductive wax from the manufacturer Solidscape is employed as the first print material. This wax has a melting point of 54 to 76° C. and is not provided with a conductive substance. Wax from the manufacturer Solidscape which has been mixed in a weight ratio of 10:1 with carbon black (Printex XE2, Degussa AG having a CTAB surface area of 600 m²/g) is employed as the wax which has been rendered electrically conductive with carbon black particles. This results in a wax/graphite mixture having a specific electrical resistance of approx. 1 Ω m. It goes without saying that the conductive wax defines electrically conductive regions of the finished dental model.

FIG. 1 shows a finished dental moulding 10 of a three-membered bridge in longitudinal section view. The dental moulding 10 comprises a matrix 12 and a veneer 14. An intermediate member 16 lies here between a first corner member 18 (on the left in the drawing) and a second corner member 20 (on the right in the drawing) and is connected to the two by connecters 11a, 11b. The corner member 18 is mounted on an abutment tooth drawn in here as a dotted line (left), and the corner member 20 is mounted on an abutment tooth likewise drawn in as a dotted line (right). The intermediate member 16 replaces a tooth which is no longer present. The dental moulding was produced by the process described in the following.

FIG. 2 shows a diagram of a finished dental model 24, which comprises a first abutment structural element 25 in the region of the left-hand corner member 18 (cf. FIG. 1). The abutment structural element 25 in turn comprises a first insulating section 21 and an electrically conductive section 22. The insulating section 21 has been printed out from insulating wax and the conductive section 22 has been printed out from conductive wax. An electrically conductive area 26 extends along the surface of the electrically conductive section 22. The abutment structural elements correspond in their proportions at least substantially to the stumps of the abutment teeth shown as dotted lines in FIG. 1. The pores inside the model have not been drawn in the diagram.

The dental model 24 furthermore comprises an intermediate structural element 19 in the region of the intermediate member 16 (cf. FIG. 1). An electrically conductive area 28 extends over the surface of the intermediate structural element 19.

Finally, the dental model 24 comprises a second abutment structural element 17 in the region of the right-hand corner member 20 (cf. FIG. 1), which comprises an electrically conductive section 27 and an electrically insulating section 15. An electrically conductive area 30 extends over the surface of the electrically conductive section 27.

The electrically conductive areas 26, 28 and 30 are areas of the surface of the particular associated electrically conductive sections 22, 23 and 27 and in the present case are conductive due to the conductivity of the electrically conductive sections 22, 23 and 27 themselves. In an alternative embodiment, the sections 22, 23 and 27 are non-conductive and merely have a thin layer of electrically conductive substance on their surface. The thickness of the electrically conductive surface areas 26, 28, 30 is approx. 0.2 mm to 1 mm in this case. In both cases the electrically conductive areas 26, 28, 30 have no porosity in the context of production accuracy.

The three electrically conductive areas 26, 28 and 30 (identified in FIG. 2 by different hatching) are electrically insulated from one another. Between the conductive area 26 and the electrically conductive area 28 there is an electrical insulation 29, and between the electrically conductive areas 28 and 30 there is a further electrical insulation 31.

When the dental model 24 is printed out, preparation edges 35a and 35b are provided on the basis of corresponding settings from the data model, which have been modelled on there in a prior working step. Furthermore, holes 32, 33, 34 are recessed into the insulating sections 15, 21, into which the dowels or electrodes engage. In the dental model 24 shown in FIG. 2, a first electrode 36 is provided, which engages into the hole 32 and contacts the electrically conductive area 26 of the abutment structural element 25 via a conductor 37. A second electrode 38 engages into the hole 33 and contacts the electrically conductive area 28 of the intermediate structural element 19 via a conductor 39, and a third electrode 40 correspondingly contacts the electrically conductive area 30 of the abutment structural element 17 via a conductor 41.

The dental model is fixed via dowels, which are not drawn in here, of which one engages into a recess 48 and a further one engages into a recess 50, to a model support, which is likewise not drawn in. The production of the rapid prototyping model in the form of the dental model is thus concluded.

For production of a dental moulding, the dental model 24 fixed to a model support is dipped in a slip bath such that the electrodes 36, 38, 40 do not come into contact with the slip.

A voltage is applied between the second electrode 38 and a slip bath electrode 54, which contacts the slip bath, which is not drawn in here, so that a defined current flows. In the present case, a stabilized mixture of ethanol and aluminium oxide powder is used as the slip. A suitable liquefying agent for aluminium oxide is polyacrylic acid, which causes high charging of the particles and at the same time assumes the function of a binder.

By application of the voltage, a layer of slip is deposited on the electrically conductive area 28 (FIG. 3). The layer thickness depends here in particular on the electric charge which has flowed, the slip material chosen and the size of the surface of the electrically conductive area 28. The layer thickness of the slip layer is the same size here at each point of the electrically conductive area 28. The size of the surface is calculated from the data model. The charge which has flowed is the product of the electrical current measured and the time measured during which this current has flowed. If the surface area and the electrical current are known, the time after which a ceramic layer of the desired thickness has been deposited can therefore be calculated or at least estimated. This time is up to a few minutes. After this time, the flow of current is interrupted. A dental model with such a ceramic layer 46 is shown in FIG. 3.

The other two electrically conductive areas 26, 30 are then contacted at the same time and ceramic layers are deposited on them in the same manner. A uniform ceramic layer, namely the later matrix, is formed by the particular ceramic layers merging.

Alternatively, ceramic is first deposited simultaneously on all the electrically conductive areas 26, 28, 30, although e.g. the voltage can remain applied for longer in area 28 in order to produce a particularly thick ceramic layer.

For the layer thickness and the form of the ceramic layer to be subsequently increased or modified further, additional slip can be applied manually. The dental moulding thus acquires the desired and characteristic form and at the same time the transmitting force to be withstood is increased.

Since no tooth which supports the bridge is present in the region of the intermediate member, in the normal case greater elastic deformation of the bridge restoration occurs in this region during chewing. To avoid this, a thicker ceramic layer is chosen (as shown) above all for the connectors 11a, 11b and the deformation is thereby reduced. The two ceramic layers deposited last therefore have a lower layer thickness than that deposited first.

The ceramic caps often have a layer thickness of <0.8 mm in the region of the corner members 18 and 20, while in some cases the ceramic in the region of the intermediate member 16 is several millimetres thick. FIG. 5 shows a ceramic layer 52 which has merged on the dental model 24 from which the cap is formed in the course of the subsequent working steps. The ceramic layer 52 which has merged has, in contrast to what is shown in the figure, a layer thickness which is the same at every point.

The dental model 24, together with the deposited, merged ceramic layer 52, is removed from the electrophoresis device. The green compact originating from the merged ceramic layer 52 is subsequently reworked by milling. During this procedure, the ceramic green compact is ground back in a defined manner at the preparation edge with a milling cutter or a grinding apparatus. FIG. 4 shows a diagram of a dental model 24 with a ceramic layer 52 deposited thereon, which ends at a preparation edge 35. A projection 43 is removed for the finishing.

FIGS. 2 and 3 show preparation edges 35a, 35b for the members of the dental model shown there. Preparation edges (preparation boundaries) can be drawn out in a defined manner and clearly as a shoulder. The demarcation of the dental moulding (e.g. cap) in the vertical direction is thus also to be detected visually after the coating. Underneath the shoulder, as shown in FIG. 4, is the foot of the tooth stump. This foot of the stump is so thick, for example, that the extension corresponds to the area of the resulting surface from the layer thickness and stump. When the shoulder is ground down to the lower surface of the preparation edge 35, the defined working of the cap in the horizontal direction takes place at the same time.

A dental moulding (cap or bridge) can be machined to the required preparation line together with the dental model (e.g. wax model). For this, the data file is preferably processed such that e.g. holes for e.g. dowels are formed at defined points on the under-side of the dental model, or the under-side is formed such that it fits in a defined manner into a mould which accommodates the model. The dental model produced in this way can then be locked together with the ceramic layer in a device with a milling cutter, which can then follow the contour with the aid of already existing data. By this route, for example, it is possible to produce a ceramic abutment, which is fixed to an implant. For this, the surface of the veneer is created by means of milling according to precisely defined geometries.

The green compact finished in this way is heated to 150° C. on the dental model in an oven. This is carried out in a powder bed. During this operation, the green compact dries and the wax (having a melting point of 54 to 76° C.) melts out. Incipient cracks in the green compact can be largely avoided by the porosity introduced inside the dental model during rapid prototyping. The green compact is subsequently subjected to final sintering at 1,300° C. to 1,700° C., so that a finished dental moulding is formed. The sinter shrinkage which thereby occurs has been taken into account during creation of the dental model, as described above, so that the dental moulding formed fits the master model with a high accuracy.

Burning out of the model and the subsequent sintering are preferably carried out in a powder bed. If the coated wax model is merely placed on a burning-out base, stresses may arise in the green compact in rare cases as a result of non-uniform melting and burning out of the model, in spite of the presence of pores. However, since this is the state in which the ceramic layer has the lowest strength, it can lead to cracks. This can be prevented by introducing the electrophoretically coated model into a powder bed. As a result, stresses and therefore destruction as a consequence of gravity and non-uniform burning away of the model do not occur. The powder bed therefore has the following tasks: a) the powder bed supports the component uniformly, b) the powder bed sucks up the wax and carries it away better.

One possibility of increasing the strength of the ceramic layer so that it survives the process step of thermal dissolving out of the model undamaged is the use of a binder. This can already be added to the slip, or it is preferably introduced on to the dried matrix.

### EMBODIMENT EXAMPLE 2

### Production of a Ceramic Component in the Form of a Cap or a Crown (Dental Moulding) by a Process According to the Invention

A master model of an individual tooth preparation is provided. This is scanned in and the data obtained are processed on the PC. During this procedure, the volume of the model to be produced is increased according to the decrease in volume during sintering, i.e. the sinter shrinkage is compensated. A cement gap which is required for cementing the caps on to the tooth stumps is taken into account when designing the geometry required. Furthermore, the preparation line is drawn out clearly as a preparation edge.

The data model is designed such that a dense, 0.2 mm thick surface of the dental model is formed during the rapid prototyping, whereas the inner volume of the dental model is built up as a porous support structure. The data model based on STL data is then converted into a dental model via the rapid prototyping (printing) process. For this, (a) an electrically insulating wax and (b) a wax which has been rendered electrically conductive with carbon black particles, such as are described above, are employed. The areas are demarcated by the preparation edge.

Alternatively, the dental model is produced from the data model by stereolithography. In this context, in each case an electrically conductive polymer is applied in layers and cured by means of UV light. An apparatus from 3d-Systems of the SLA 7000 type e.g. is employed for this.

The electrically conductive area of the finished dental model is contacted and dipped, together with a counter-electrode, into a slip bath comprising the slip described above.

After application of a voltage, a ceramic layer is deposited in a finished form after a few seconds up to some minutes, depending on the desired layer thickness and the current flow set and the voltage.

The ceramic green compact produced in this way is dried together with the dental model. The ceramic green compact of the cap is ground back in a defined manner at the preparation edge using a milling cutter or a grinding apparatus. Additional slip can optionally be applied to modify the contour. The model is then separated out thermally. This is carried out at temperatures of between 54 and 76° C., since the melting point of the wax is already reached here. Residues of the wax which have not flowed out due to wetting burn without residue during the further increase in temperature. Alternatively, the model can be dissolved out chemically. The alternatively used rapid prototyping model made from polymer which has been cured via UV radiation is burned out completely at temperatures up to 550° C.

Due to the pores present, the removal of the rapid prototyping model is not associated with damage to the coating.

Sintering of the green compact is carried out at temperatures of from 1,300° C. to 1,700° C. The ceramic particles of the green compact sinter together, so that a decrease in volume occurs. This decrease in volume has been taken into account beforehand, see above. The ceramic matrix is subjected, for example, to dense sintering or superficial sintering. Glass is additionally infiltrated to increase the strength.

The ceramic cap obtained or the crown obtained (dental moulding) fits the master model and therefore the tooth preparation with a high accuracy. It has a high density of more than 90% and therefore has a high strength. It cannot be and is not subsequently infiltrated by glass.

As an alternative to the dense sintering at high temperatures described for the ceramic cap (dental moulding), the green compact can be superficially sintered at temperatures of between 1,000 and 1,300° C. This is associated with only a low decrease in volume, but also a remaining high porosity. This porosity can be filled up by glass infiltration in a subsequent step. Since the decrease in volume is only low, in this alternative procedure the volume of the dental model to be produced is also increased only slightly compared with that of the master model.

### EMBODIMENT EXAMPLE 3

### Production of a Ceramic Component in the Form of a Ceramic Microcomponent

This embodiment example relates to a toothed wheel (microcomponent) in the form of a spur wheel. The working diameter (reference diameter) of this spur wheel is 500 μm, the number of teeth is z=10. This results in a modulus of m=50 μm. The toothed wheel has an internal bore of 150 μm.

The data model for the later rapid prototyping process for production of the toothed wheel is generated on the computer. It is taken into account here that the ceramic green compact produced with the aid of the data model shrinks during sintering. The geometry of the data model is enlarged according to this decrease in volume. With the aid of these CAD data (data model) of the ceramic green compact of the toothed wheel, a negative of the toothed wheel enlarged by the sinter shrinkage, which is aligned such that its axis is perpendicular to the horizontal, is created on the computer. In addition, this negative is divided into horizontal layers of the same thickness. This negative is produced by means of the rapid prototyping process of stereolithography. A photocuring resin which has been rendered electrically conductive by the addition of carbon black is used for the production. A first layer of the mixture of photocuring resin and carbon black is applied to an electrically non-conductive substrate by stereolithography and is cured completely. The application of layers is then carried out, with subsequent selective exposure to light according to the set of data generated.

After the building up and the selective curing of the last layer, the substrate is removed from the stereolithography apparatus together with the rapid prototyping model. The rapid prototyping model is then freed from the excess, still liquid resin. The rapid prototyping model remains in the form of an electrically conductive negative mould for the toothed wheel, enlarged by the sinter shrinkage, on the non-conductive substrate. This negative mould is contacted electrically and dipped into a ceramic slip. The composition of the slip corresponds to that in the first embodiment example.

After application of a voltage, the rapid prototyping model (negative) fills with slip and the slip is deposited electrophoretically as a ceramic layer on the electrically conductive surface of the rapid prototyping model. When the rapid prototyping model (negative) has been filled out with the ceramic layer, the rapid prototyping model is removed from the slip bath. The rapid prototyping model, together with the substrate to which the rapid prototyping model is joined, is clamped in a mortizer. The excess slip deposited is then removed from the surface of the mould facing upwards by milling. In this milling process, the through hole of the later toothed wheel is also produced and a good planar parallelism of the toothed wheel sides is established. In a subsequent heat treatment (see above), the model is removed from the mould and the ceramic microcomponent in the form of the toothed wheel is subjected to dense sintering.

### EMBODIMENT EXAMPLE 4

### Production of a Metallic Component by a Process According to the Invention

FIG. 6 shows a rapid prototyping model 55 according to the invention for electrolytic deposition for the production of a component 56, which is drawn in as a broken line. The pores inside the model are not drawn in the diagram.

The component 56 is flat and has a reliefed surface on one of its sides, which is facing downwards in FIG. 6.

A digital data model of the component is first created with the aid of a computer. The negative of the reliefed surface is then calculated. The rapid prototyping model 55 is produced by ballistic particle manufacturing with the aid of these geometric data. The wax described above and the mixture of this wax and carbon black described above are employed for this.

The rapid prototyping model 55 is circular in cross-section; a cross-section parallel to the longitudinal axis of the vertical rapid prototyping model 55 is shown in FIG. 6. The rapid prototyping model 55 comprises three sections 60, 62, 64. Section 60 is produced from electrically non-conductive wax, and the two sections 62 and 64 are made of electrically conductive wax. Section 60 runs out into a circumferential projection 66, which serves to fix the rapid prototyping model 55 on a model support. The two sections 62 and 64 run out downwards into peg-like projections 68, 70, which serve for electrical contacting of the two regions 62 and 64 respectively. Section 62 has an electrically conductive area 72 on its upwards-facing surface. Section 64 correspondingly has an electrically conductive area 74 on its upwards-facing surface.

After production of the rapid prototyping model 55, this is first reworked by removal of material by polishing the electrically conductive areas 72, 74. The rapid prototyping model 55 is then first filled with a solution 76 of a silver salt. An electrode 78 connected electrically to a current source 80 is immersed in this solution. The current source 80 is then connected electrically to the peg-like projection 70 of the section 64 and a voltage is applied between the electrode 78 and the section 64. As a result of this, silver is deposited on the electrically conductive area 74 of the section 64. The flow of current is maintained until a silver layer of the desired thickness has been deposited on the electrically conductive area 74. The thickness of the silver layer can be determined from the charge which has flowed, which results as the product of the current strength and the time, and the area of the electrically conductive area 74, which is calculated from the geometric data on which the production of the rapid prototyping model 55 is based.

The solution 76 is then removed, the model is filled with a copper salt solution and the projections 70 and 68 are connected electrically to one another. A copper layer is then deposited on the electrically conductive area 72 and the silver layer deposited on the electrically conductive area 74 by application of a voltage between the electrode 78 and the sections 62 and 64. The electrolysis is interrupted as soon as the desired thickness of the copper layer is reached. The thickness of the layer is chosen here such that the component 56 is self-supporting. In a subsequent working step, the rapid prototyping model 55 is removed by dissolving out the wax with an acid which does not attack the metals. The component 56, the reliefing of which represents an accurate image of the reliefing modelled on the computer, remains.

### EMBODIMENT EXAMPLE 5

### Production of a Rapid Prototyping Model with a Metallic Coating

This embodiment example relates to the production of a galvanized or electrolytically coated part of plastic. The metallic coating serves for functional or visual purposes. The part of plastic is designed on the computer by means of CAD. A base body of plastic is built up with the aid of the CAD data using the rapid prototyping process of fused deposition modelling. The material employed in the rapid prototyping process is a thermoplastic having a filler content of silver. The base body of plastic produced is contacted electrically and dipped in an electrolyte which contains nickel sulfamate and in which the counter-electrode is already present. After application of a voltage between the counter-electrode and the rapid prototyping model, deposition of nickel occurs on the electrically conductive areas of the surface of the rapid prototyping model. A nickel layer about 100 μm thick is built up. The layer thickness is regulated via the time or measurement of the flow of current. After-treatment of the new surface generated in this way is possible, for example by polishing, depending on the case of use.

Other components, such as, for example, injection moulds, dies, mirrors, gold matrices for dentistry, pressing plates for application of grain in the production of artificial leather and ceramic separate parts, can also be produced in a corresponding manner. Processes according to the invention can be employed particularly advantageously for the production of very small series of components of complex geometry.

1. Process for the production of a rapid prototyping model (24;55), in particular a rapid prototyping model (24;55) for electrolytic or electrophoretic deposition, with the steps:
providing a mixture of one or more fluid, solidifiable materials and one or more electrically conductive substances and subsequently
producing the rapid prototyping model (24;55) by rapid prototyping using the mixture, such that the rapid prototyping model produced (24;55) is electrically conductive in one or more areas (26,28,30;72,74) of its surface due to the presence of the electrically conductive substance or substances and has a porous structure in its inside.

2. Process according to claim 1, characterized in that graphite, carbon black, other conductive substances based on carbon and/or metal particles, in particular silver particles, are used as electrically conductive substances.

3. Process according to claim 1, characterized in that in the production of the rapid prototyping model (24;55), the fluid, solidifiable material or the fluid, solidifiable materials are solidified to form a matrix in which the electrically conductive substance or the electrically conductive substances are embedded so that these, together with the matrix, form a solidified mixture, the specific electrical resistance of which is less than 500 Ohm Ω m.

4. Process according to claim 1, characterized in that the content of electrically conductive substances in the electrically conductive area of the surface is more than the percolation concentration, determined at the same relative concentrations of the electrically conductive substances.

5. Process according to claim 1, characterized in that the fluid, solidifiable material or the fluid, solidifiable materials is or are chosen from the group consisting of wax and plastic.

6. Process according to claim 1, characterized in that at least one electrically conductive substance is a fluid, solidifiable material.

7. Process according to claim 1, characterized in that the rapid prototyping model is produced by additive rapid prototyping process comprising fused deposition modelling, stereolithography and/or 3D printing, such as inkjet modelling and/or ballistic particle manufacturing.

8. Process according to claim 1, with the additional step:
providing a fluid and solidifiable material which is electrically insulating in the solidified state, the rapid prototyping model being produced by rapid prototyping using this material and the mixture such that at least two electrically conductive areas of its surface are each demarcated from the electrically insulating material such that they are electrically insulated from one another.

9. Process according to claim 1, characterized in that the rapid prototyping model is produced such that it is electrically conductive in parts of its volume and the electrically conductive areas (26,28,30;72,74) of its surface are contacted through the electrically conductive parts of its volume (25,19,27;62,64).

10. Process according to claim 1, characterized in that the rapid prototyping model (24;55) is produced by stereolithography and the fluid, solidifiable materials are photocurable and are chosen from the group consisting of photocuring resin and photocurable wax.

11. Process according to claim 1, with the additional steps:
after provision of the mixture, solidifying the mixture so that a pre-formed body, in particular in the form of a block, is formed and
producing the rapid prototyping model (24;55) by milling.

12. Process for the production of a ceramic green compact, with the steps:
production of a rapid prototyping model (24;55) according to claim 1
reducing the surface imperfections of the rapid prototyping model
electrophoretically depositing a slip on the rapid prototyping model, so that a ceramic layer forms,
drying the ceramic layer deposited,
working the ceramic layer and/or the rapid prototyping model by removal of material, additional application of ceramic material to the ceramic layer and/or by application of a solidifying agent and
removing the model by melting out, burning out or dissolving out,
so that a ceramic green compact is formed.

13. Process for the production of a ceramic component, with the steps:
production of a green compact according to claim 12,
reworking of the surface of the green compact by removal of material and
heat treating the green compact,
so that a ceramic component is formed.

14. Process according to claim 13, characterized in that the heat treatment of the green compact is a sintering to give a porous or to give a dense ceramic component.

15. Process for the production of a rapid prototyping model (24;55) with a metallic coating, with the steps:
production of a rapid prototyping model (24;55) according to claim 1,
reduction of the surface imperfections, and
electrolytic or electrophoretic deposition of a metal layer on the rapid prototyping model, so that a model with a metallic coating is formed, and
optionally reworking of the metallic coating and/or of the rapid prototyping model, preferably by milling and/or polishing.

16. Process for the production of a metallic component (55), with the steps:
production of a rapid prototyping model (24;55) with a metallic coating according to claim 15, wherein the metal layer is self-supporting, and
removal of the rapid prototyping model (24;55), in particular by melting out, burning out or dissolving out, so that the self-supporting metal layer remains as a metallic component (55).

17. Process according to claim 12, characterized in that the rapid prototyping model is electrically conductive in at least two areas of its surface which are electrically insulated from one another, and in that during the electrolytic or electrophoretic deposition of the metal layer or the electrophoretic deposition of the slip on the rapid prototyping model, these at least two areas electrically insulated from one another
(a) are placed under a voltage at different points in time and/or are connected without a voltage and/or
(b) are placed under voltages which differ from one another,
so that a metallic coating and/or slip are deposited in different layer thicknesses on the at least two areas which are electrically insulated from one another.

18. Process according to claim 1, characterized in that a metal layer is deposited electrolytically or electrophoretically on a ceramic layer deposited on the rapid prototyping model, and/or a ceramic layer is deposited electrophoretically on the metal layer deposited on the rapid prototyping model.
